(19) United States
(12) Patent Application Publication
(10) Pub. No.: US 2017/0357669 A1
(43) Pub. Date: Dec. 14, 2017

(54) METHOD FOR OPERATING A COEFFICIENT OF FRICTION DATABASE, AND COEFFICIENT OF FRICTION DATABASE

(71) Applicant: Robert Bosch GmbH, Stuttgart (DE)

(72) Inventors: Andreas Offenhaeuser, Marbach Am Neckar (DE); Erik Lesser, Steinheim (DE); Nils Hagenlocher, Stuttgart (DE)

(73) Assignee: Robert Bosch GmbH, Stuttgart (DE)

(21) Appl. No.: 15/536,438

(22) PCT Filed: Jan. 15, 2016
(86) PCT No.: PCT/EP2016/050736

§ 371 Date: Jun. 15, 2017

(30) Foreign Application Priority Data
Jan. 29, 2015 (DE) 10 2015 201 525.4
Aug. 28, 2015 (DE) 10 2015 216 483.7

(51) Int. Cl. G06F 17/30; B60W 40/076; B60W 40/068

(52) U.S. Cl. CPC G06F 17/30241; B60W 40/068; B60W 40/076; G06F 17/30038

(57) ABSTRACT

A method for operating a coefficient of friction database includes receiving information, that is output by transmitting vehicles and that includes coefficient of friction data describing an ascertained coefficient of friction potential of a road segment, location data describing a geometrical position of the road segment, and time data describing an instant of ascertainment of the coefficient of friction data or describing the coefficient of friction potential, and storing the information in a coefficient of friction database from which the data is then retrievable by receiving vehicles.

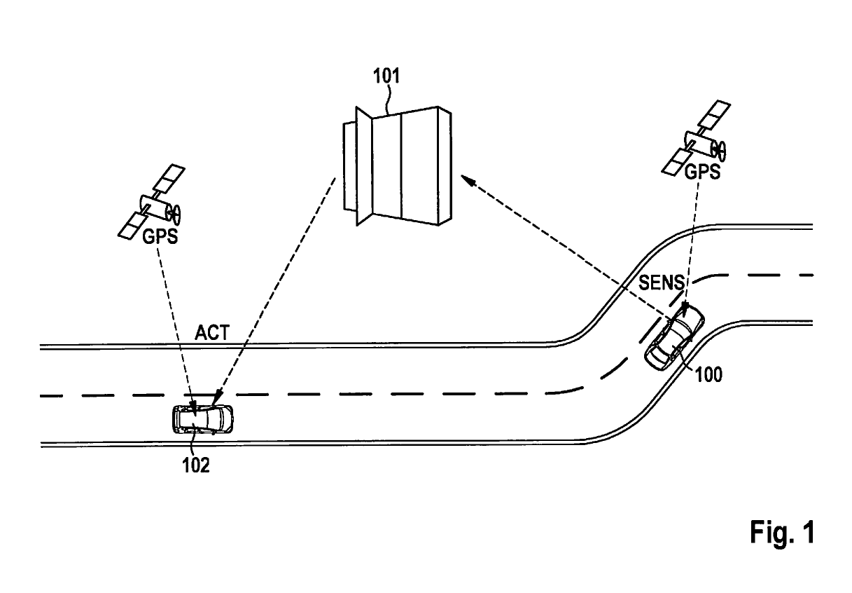

### CROSS-REFERENCE TO RELATED APPLICATIONS

The present application is the national stage of International Pat. App. No. PCT/EP2016/050736 filed Jan. 15, 2016, and claims priority under 35 U.S.C. § 119 to DE 10 2015 201 525.4, filed in the Federal Republic of Germany on Jan. 29, 2015 and to DE 10 2015 216 483.7, filed in the Federal Republic of Germany on Aug. 28, 2015, the content of all of which are incorporated herein by reference in their entireties.

### FIELD OF THE INVENTION

The present invention relates to a method for operating a coefficient of friction database and to a method for the exchange of information with a coefficient of friction database.

### BACKGROUND

A method for evaluating a sensor signal that is suitable for detecting an object in a vehicle environment is known from DE 10 2008 043 743 A1. An item of object information can be provided as a transmit signal to a communications interface in order to allow for a transmission of the item of object information to a road maintenance facility, for example. Road maintenance facilities and other authorities responsible for roads are then able to ascertain the state of traffic signs and roads in an uncomplicated manner.

### SUMMARY

According to an example embodiment of the present invention, information, that is output by transmitting vehicles and including an ascertained coefficient of friction potential of a road segment (or coefficient of friction data describing the ascertained coefficient of friction potential of a road segment), location data describing a geometrical position of the road segment, and time data describing an instant of ascertainment of the coefficient of friction data or describing the coefficient of friction potential, is received and stored in a coefficient of friction database from which the data is then retrievable by receiving vehicles.

As a result, the receiving vehicle is able to adapt driving-safety systems to the current coefficient of friction conditions of the current road section and thereby reduce an accident risk.

A characteristic of an advantageous further refinement of the present invention is that a plausibilization of the received coefficient of friction data takes place in the coefficient of friction database.

A characteristic of an advantageous refinement of the present invention is that the plausibilization is carried out by comparing the received coefficient of friction data with current weather information.

A characteristic of an advantageous further refinement of the present invention is that the plausibilization is carried out by comparing the received coefficient of friction data with coefficient of friction data received from another transmitting vehicle whose provided location data alone or additionally time data substantially match those of the received data. “Matching substantially” means that any deviations between the relevant received data and the relevant data received from another transmitting vehicle do not exceed a specified threshold value.

A characteristic of an advantageous further refinement of the present invention is that feedback to a transmitting vehicle takes place in the event that the coefficient of friction data are not plausible.

A characteristic of an advantageous further refinement is that a transmitting vehicle transmits coefficient of friction data to the database if these data were obtained during a control intervention of an electronic stability system, an antilock braking system, or a traction control system. In this case it can be assumed that the exploited coefficient of friction lies very close to the coefficient of friction potential.

A characteristic of an advantageous further refinement of the present invention is that a transmitting vehicle transmits coefficient of friction data to the database if these data were obtained by evaluating steering interventions.

A characteristic of an advantageous further refinement of the present invention is that a transmitting vehicle transmits coefficient of friction data to the database if these data were obtained by an optical vehicle sensor system. An optical sensor system allows for a detection of the condition of the road surface and its coefficient of friction potential.

According to an example embodiment of the present invention, a control device in a motor vehicle transmits or receives coefficient of friction data, time data and location data to/from a coefficient of friction database operated using one of the methods described herein.

According to an example embodiment, a coefficient of friction database includes information that is output by transmitting vehicles and that includes an ascertained coefficient of friction potential of a road segment (or coefficient of friction data describing the ascertained coefficient of friction potential of a road segment), location data describing a geometrical position of the road segment, and time data describing an instant of ascertainment of the coefficient of friction data or describing the coefficient of friction potential, where the information is is retrievable by receiving vehicles.

### BRIEF DESCRIPTION OF THE DRAWINGS

The Figure shows a structure of a centralized coefficient of friction ascertainment via a vehicle sensor system, according to an example embodiment of the present invention.

### DETAILED DESCRIPTION

A coefficient of friction map can be created according to a method in which a plurality of vehicles transmit their geo-encoded coefficient of friction road information to a vehicle-external arithmetic unit or a Cloud. This transmittal of the information takes place only at times when reliable coefficient of friction information is available. In the Cloud, this information is aggregated on the basis of its geo positions and plausibilized with the aid of additional data such as weather information. The new information thusly obtained can then be made available to all users. Given sufficient scaling of the system, it is therefore possible to set up a highly dynamic coefficient of friction map of all roads. The system topology of the centralized coefficient of friction ascertainment via the vehicle sensor system, according to an example embodiment, is illustrated in the Figure. The system uses vehicle 100 as a sensor for ascertaining coefficients of friction of the road. This is denoted by SENS in the Figure. In this context, either the coefficient of friction estimators already provided in an electronic stability program of the vehicle, or the coefficients of friction ascertained with the aid of optical vehicle sensors can be used for this purpose. Information about the coefficients of friction is also able to be obtained by analyzing steering maneuvers of the vehicle as well as by estimation algorithms within or external to a vehicle electronic stability program. The ascertained instantaneous coefficients of friction together with the instantaneous GPS position are transmitted to a central server system 101. The GPS position is determined with the aid of the satellites denoted by GPS.

In a coefficient of friction estimate with the aid of algorithms stored in an electronic stability program, an antilock braking system or a traction control system, it is always the utilized coefficient of friction that is ascertained. This coefficient of friction can differ significantly from the actually present coefficient of friction potential. This is particularly the case when the vehicle is not moving in a limit range in terms of vehicle dynamics and an even stronger acceleration or deceleration of the vehicle would be possible.

Another aspect of the system according to an example embodiment of the present invention is acquisition of the coefficient of friction potential. To do so, the information packets sent to server 101 must always be transmitted only at the instants at which the estimated coefficient of friction lies close to the maximum coefficient of friction potential. For example, this is the case when control interventions of a traction control system or an antilock braking system are occurring. At low coefficients of friction such as when the road is covered by ice or snow, these events occur very frequently, meaning that the coefficient of friction information stored in server system 101 will be very up-to-date. At high coefficients of friction, barely any control interventions of the vehicle safety systems occur, which would have the result that no sensor information is available. For this reason, it is useful to make coefficient of friction information available to server system 101 even if no control interventions are encountered. For example, this can be done when very high accelerations in the longitudinal or transverse direction are taking place. A high acceleration always means that a very high coefficient of friction was exploited and is available. Another possibility includes ascertaining the coefficient of friction potential of the road directly with the aid of optical methods. This information is then able to be transmitted to server 101 at any time.

Server 101 receives coefficients of friction with a position indication from different vehicles and plausibilizes this information with the aid of external sources. The external sources, for example, can be weather information, older coefficient of friction data, road maps or data from road operators. Server 101 then makes the aggregated coefficient of friction information available to other vehicles 102.

The information packets supplied by or received from vehicles 100 and 102 have to be interpreted correctly. Since the coefficient of friction potential always depends on the state of the road and also the tires of the vehicle, it is possible that different vehicles 100 report different coefficient of friction potentials to server 101 at the same location. In the server, this can be taken into account by averaging the supplied data, for example. Such averaging even allows the server to supply feedback to transmitting vehicle 100 about the state of its tires. For example, a sign of worn tires in the case of vehicle 100 can exist if multiple vehicles have transmitted a considerably higher coefficient of friction potential at the same location directly prior to the transmission instant of the coefficient of friction potential of vehicle 100.

Vehicle 102 denoted by ACT receives the aggregated coefficient of friction potential from server 101 and in response adapts the parameters for an electronic stability program, a vehicle movement control, an antilock braking system, a traction control system or a trajectory schedule, for example, in accordance with the received information. This can lead to an adaptation of the vehicle speed or the maximally permitted drive or brake forces. It is also possible, even before a curve comes into view, to reduce the vehicle speed in such a way that accelerations in the longitudinal or transverse direction that occur during cornering are lower than the maximally possible accelerations on the basis of the aggregated coefficient of friction potentials.

1-11. (canceled)

12. A method for operating a coefficient of friction database, the method comprising:
receiving information output by transmitting vehicles and that includes (a) coefficient of friction data describing an ascertained coefficient of friction potential of a road segment, (b) location data describing a geometric position of the road segment, and (c) time data describing an instant of ascertainment of the coefficient of friction data;
storing the received information in the database, from which the stored data is retrievable by receiving vehicles.

13. The method of claim 12, further comprising performing a plausibilization of the received coefficient of friction data.

14. The method of claim 13, wherein the plausibilization is carried out by comparing the received coefficient of friction data with instantaneous weather information.

15. The method of claim 13, wherein the plausibilization is carried out by comparing the received coefficient of friction data with coefficient of friction data received from at least one further transmitting vehicle whose location data substantially matches the received location data.

16. The method of claim 13, wherein the plausibilization is carried out by comparing the received coefficient of friction data with coefficient of friction data received from at least one further transmitting vehicle whose location data and time data substantially match the received location data and received time data.

17. The method of claim 13, further comprising providing feedback to a transmitting vehicle in response to a determination that the coefficient of friction data are not plausible.

18. The method of claim 12, wherein a transmitting vehicle (100) transmits coefficient of friction data to the database (101) if these data were obtained during a control intervention of an electronic stability program, an antilock braking system or a traction-control system.

19. The method of claim 12, wherein the transmitting vehicles are configured to transmit the coefficient of friction data to the database conditional upon that the data was obtained in at least one predefined state, wherein the at least one predefine state includes obtaining the coefficient of friction data by evaluating steering interventions.

20. The method of claim 12, wherein the transmitting vehicles are configured to transmit the coefficient of friction data to the database conditional upon that the data was obtained in at least one predefined state, wherein the at least one predefine state includes obtaining the coefficient of friction data using an optical vehicle sensor system.

21. A control device in a motor vehicle that transmits to a device for storage in a coefficient of friction database information that includes (a) coefficient of friction data describing an ascertained coefficient of friction potential of a road segment, (b) location data describing a geometric position of the road segment, and (c) time data describing an instant of ascertainment of the coefficient of friction data, wherein the information is retrievable from the database by a plurality of vehicles.

22. A non-transitory computer-readable medium on which are stored instructions that are executable by a processor and that, when executed by the processor, causes the processor to perform a method for operating a coefficient of friction database, the method comprising:
receiving information output by transmitting vehicles and that includes (a) coefficient of friction data describing an ascertained coefficient of friction potential of a road segment, (b) location data describing a geometric position of the road segment, and (c) time data describing an instant of ascertainment of the coefficient of friction data;
storing the received information in the database, from which the stored data is retrievable by receiving vehicles.
